(19) United States
(12) Patent Application Publication
(10) Pub. No.: US 2002/0129340 A1
(43) Pub. Date: Sep. 12, 2002

(54) Reconfigurable isomorphic software representations

(76) Inventor: Douglas D. Tuttle, San Francisco, CA (US)

Correspondence Address: FENWICK & WEST LLP, TWO PALO ALTO SQUARE, PALO ALTO, CA, 94306, US

(21) Appl. No.: 10/010,757

(22) Filed: Nov. 8, 2001

Related U.S. Application Data
(63) Continuation-in-part of application No. 09/429,853, filed on Oct. 28, 1999.
(60) Provisional application No. 60/247,371, filed on Nov. 8, 2000.

(51) Int. Cl. G06F 9/44

(52) U.S. Cl. 717/132

(57) ABSTRACT

Data flow graph representation is combined with message passing and delegation, a stackless execution model, and a real-time compiler technology, to provide an improved software development and distribution paradigm. Polymorphic objects represent nodes that can be reconfigured, replaced, and/or modified as needed. Complex functionality is achieved by passing messages among nodes. Authored content is published by replacing interactive nodes with fixed-value nodes as desired. Software representations can be translated among various isomorphic formats, including data flow graphs and scripts, without loss of information or modifiability.

### CROSS-REFERENCE TO RELATED APPLICATIONS

The present application is a continuation-in-part of U.S. patent application Ser. No. 09/429,853 for “Online Focused Content Generation, Delivery, and Tracking,” filed Oct. 28, 1999, the disclosure of which is incorporated herein by reference. The present application further claims priority from provisional U.S. patent application Ser. No. 60/247,371 for “Reconfigurable Isomorphic Software Representations,” filed Nov. 8, 2000, the disclosure of which is incorporated herein by reference.

### BACKGROUND OF THE INVENTION

1. Field of the Invention

The present invention is related to development and representation of software, and more particularly to representing software applications through the use of data flow graphs and for facilitating self-modifying software.

2. Description of the Background Art

One problem that is prevalent in much of the software being developed according to currently available methods is its inflexibility. The real world demands flexible solutions to ever-changing problems; yet currently available software that is used to address those problems is relatively rigid, inflexible, and difficult to adapt to changing needs. Often, the burden is on the user to find creative ways to deploy software to effectively solve real-world problems.

Although software capabilities have improved dramatically, the trend toward ever more complex and larger programs has resulted in many examples of software that is less flexible and less capable of serving future needs of users. Monolithic applications containing more and more features often fail to provide the streamlined, effective solution a user is seeking.

As is known to those skilled in the art, computer languages allow programmers to write instructions or commands to a computer in a manner that is understandable by humans while ultimately readable by machines. Underlying each computer language is an implicit execution model, a set of rules defining how programs written in the language will function. The execution model determines what a program written in a particular language can and cannot do, and as such is often more important than the particular syntax employed by the language. In many situations, software applications attempt to duplicate the algebra of real-world objects. Binary data is used to represent real-world objects, and software code is written to make changes to data structures in a manner that mimics the real-world behavior of the objects. To the extent that a computer language is limited in what it can represent, the algebra of real-world objects can only be approximated, not duplicated. This is a common problem in conventional software applications and languages.

Most commonly used computer languages, such as FORTRAN, C, and C++, employ an execution model based on a subroutine execution stack. This paradigm tends to restrict the sequence of operations to a hierarchical model in which the execution order is represented by a tree structure. Although many simple problems can be mapped onto a tree structure, real-world problems are often too complex for such mapping to be substantially accurate. Such problems are better addressed by being mapped onto a data graph structure rather than a tree structure.

For example, when an error or exception condition arises in a system employing a conventional hierarchical model, an entirely new execution model is often used for handling the condition. Such an approach fails to take into account the fact that, in the real world, such exceptions are generally quite common, so that exception handling is better treated as the only execution model, rather than as a special case.

Furthermore, most software is built using a “compile, link, load and run” paradigm. Such a methodology yields executable code that is relatively small and fast, but in a rigid, non-modifiable form—the executable binary. Once a program is in executable binary form, it cannot generally be modified, either by a programmer or by the program itself. In addition, a program in executable form can, in general, only be run on one type of computer. Thus, the “compile, link, load and run” software development paradigm yields code which is relatively inflexible and which in general cannot be adapted to changing needs without replacing the entire program. Changes and revisions thus typically entail providing entirely new code to replace the previous code, either by shipping a new CD-ROM or by providing the new code to users via a network connection.

The inflexibility of software has led to ever-enlarging releases of commercial software applications. Because the software cannot be altered once it has been compiled and distributed to customers, developers often include large quantities of special-purpose code to address possible situations, options, or functionality that may ultimately be needed by only a fraction of the overall user base. Software applications thus become much larger than they otherwise would be, and often still fail to anticipate the needs of many consumers. Furthermore, the monolithic style of releasing software demands that entire applications be provided in one package, either on a CD-ROM or via a single large download. The concept of providing software in small pieces as needed is not generally known in the art as a distribution paradigm.

Furthermore, while existing compiler technology converts source code into its equivalent expressed in the native instructions of the central processing unit (CPU), thus providing advantages in speed and size of the final result, the compiling process strips away the information necessary to make the software comprehensible to a human. In general, the source code cannot be recreated from the executable binary. In addition, the process of linking generally removes any modularity that may be of use in later modifying the software code.

Some software employs an interpretive language to enable greater flexibility in distributed software. An interpreter executes the source code on an as-needed basis. Examples of such a methodology include Java and Basic. In some implementations, source code is converted to byte codes, which are executed by a program on the target CPU.

Unfortunately, interpreted programs tend to be slow. There has been some use of JIT compilers, which compile the code into native form on a just-in-time (JIT) basis. By compiling to native code, such systems avoid the speed limitations of interpreted software. However, JIT compilers only optimize the code once for all situations, and therefore are limited in the type of optimizations that can be made. Furthermore, JIT compilers are generally incapable of optimizing across modules, and are unable to recompile on the fly, since conventional computer languages do not allow a program to alter itself while it is running. Another problem with conventionally compiled software is that, because of the rigidity of conventional computer languages, there is generally no mechanism for such languages to express changes to the code itself. As a result, self-modifying code is not generally known or widely used. The methodology of compiled programs provides no mechanism for the programming language to provide information about the program itself.

Some existing languages allow programmers to rewrite or add to programs while they are running. In general such languages provide a vocabulary and syntax for talking about parts of the program itself. Self-referential languages of this type are referred to as “meta-cyclic.”

One example of a meta-cyclic language is LISP, which has become very well known as an archetype for self-referential languages. LISP is an interpreted language that provides an example of how the representation of a program can extend its functionality. The basic building blocks of a LISP program are lists of symbols, strings and numbers. A list of strings can represent data, or it can represent code. For example:

(1 2 3) may represent a list of numbers

((1, 2, 3), (4 5 6), 7, 8, (9, 10, 11)) may represent a list of lists

(‘hello’, ‘little’, ‘brown’, ‘dog’) may represent a list of strings

(function, ‘little’, ‘brown’, ‘dog’) may represent a function call with 3 arguments

The final example is software code, yet it is also a normal list; that is, it represents both code and data at the same time. In fact, all the usual computer language constructs, such as loops, if-then-else blocks, and the like, are presented as functions in LISP. Even sequential lines of code are constructed as lists of lists. Everything in LISP is therefore built up out of these extremely simple atomic primitives.

Since LISP allows the creation and manipulation of lists, it automatically allows the creation and manipulation of code. The following LISP function takes a list of lists and makes a new function out of it:

(lambda (fred arg1 arg2) (code-goes-here)) creates the function fred

The elegant simplicity and self-modifying nature of LISP has made it popular in academic research; however, it is rarely used in commercial applications. The simplicity of the language makes programs notoriously difficult to read, and because LISP is interpreted, program execution tends to be slow. The self-modifying nature of LISP programs is invisible to the end user, and remains an implementation detail. In addition, LISP employs a standard hierarchical execution model that imposes its own limitations.

### Object-Oriented Programming

Many applications are developed using object-oriented programming, as is known in the art. Object-oriented programming provides a set of software techniques for managing modularity. In object-oriented programing, design modules are referred to as objects. As is known in the art, object-oriented programming employs a collection of ideas that work together, including encapsulation, messages, classes, inheritance, and delegation. Each of these will be discussed in turn.

### Encapsulation

In general, software includes both code and data. Early computer programs kept these separate; however, more recent computer programming techniques recognize that both code and data can be considered to be alternative representations of the same entity. Data represents the current state of an object, and code represents the object's behavior. When the code is executed, the data changes state, for example in lock-step with a real-world object that the software object is representing or approximating.

Thus, in object-oriented programming, data and code are bundled together in a unit. The unit, which is also the unit of modularity, is known as an object.

In addition, object-oriented programming techniques dictate that an object's data is locked away inside the object, so that the only code that is permitted to access the data is the code that is inside the object itself. The bundling of code and data inside this barrier is known as encapsulation. An object is like a sealed container with an internal state and behavior. It is therefore capable of representing both the state and behavior of a real-world object or symbolic idea.

As is known to one skilled in the art, encapsulation is important because it isolates dependencies. Objects encapsulate their code and data, but publicly export an interface as a way to synchronize their behavior with other objects in the system. Encapsulation enables modularity in application development. Without encapsulation, modules develop intertwined dependencies that make improvements difficult.

### Messages

Objects communicate with one another by sending and receiving messages. When a message is sent to an object, the object performs appropriate actions, including changing its internal data variables, sending a message to another object, or doing nothing at all. Messages do not require the object to behave in a particular way; rather, the object's actions are determined according to its own internal rules of behavior, so that the object responds to a received message accordingly.

In object-oriented systems, messages are sent according to techniques that are similar to standard subroutine calls. The flow of control is transferred to the target object, and is returned to the sender when the target object is finished. In fact, this operation usually is accomplished using an actual subroutine call, except that the call is into encapsulated code inside the object. The sender performs a call operation, but, unlike standard languages, it is not necessarily known where the target object is located. Instancing and Classes

When an object gets copied, the copy contains everything that was in the original object, including both data and code. Although the original object and its copy are still of the same type and have the same internal variables and code, they may evolve independently, depending on the messages each receives. Copies of objects that are generated in this manner are called instances, and the operation of copying an object in this manner is called instancing.

Many conventional object-oriented architectures define a number of object classes. In general, any object that has different internal data, or code, or responds to messages differently, is considered to belong to a different class. Thus, instancing produces copies of objects from the same class. If two classes support the same set of messages, but are implemented differently, they are said to be polymorphic.

In general, new functionality is added to such systems by creating new classes. These can be created from scratch, or by reusing classes already in the system.

### Inheritance

Inheritance is a technique for defining relationships among objects. When an object inherits from another object, it adds its own data and code to the code and data of the object from which it is inheriting. This creates a new class, called a derived class or subclass; the original class is referred to as a superclass.

Inheritance is a useful and widely used technique, but it raises significant problems when implemented in a strict object-oriented system. Firstly, inheritance can sometimes be incompatible with encapsulation. If the derived class has access to the inherited data, then the implementation of the superclass cannot be changed without changing the derived class. This undermines the encapsulation and the fundamental modularity of the system. If encapsulation is preserved, and the both the superclass and the subclass support the same message, a conflict may arise in determining which class receives the message. If both classes are to receive it, a timing conflict may arise as to which class receives the message first. Often the sequence of message receipt has significant consequences for the operation of the system. Since most object-oriented systems contain many layers of inheritance, the number of possible sequences can often be unwieldy.

Many object-oriented systems also provide multiple inheritance, allowing a derived class to inherit from more than one superclass. This can exacerbate the above-described conflicts and further increase the complexity of object relationships, in that there are now three or more classes that need to respond to a message.

Inheritance can take place at compile-time or at run-time. For polymorphic objects, run-time inheritance can be advantageous, since the inheritances may be changed as desired. However, most object-oriented languages use the “compile, link, load and run” paradigm, and therefore cannot provide run-time inheritance.

Inheritance also leads to upside-down taxonomies. For example, in a software architecture that models an automobile in a computer, an object structure would be generated as follows. We begin with an abstract idea we call the automobile, then break that into subsystems like body, frame, suspension, engine, interior, safety systems, and the like. Each of these is further broken down into smaller and smaller subsystems, ultimately reaching individual parts such as bolts, pistons, body panels, and the like. Finally, these individual parts combine the behavior of primitive attributes such as materials, geometry, and manufacturing tolerances. This leads to a very natural top-down hierarchy.

However, building an automobile using standard inheritance techniques would dictate that we start with primitives and build up to larger classes of object by inheriting from the smaller ones. The primitive objects are located at the top of the hierarchy, and are combined into large subsystems as we go down the hierarchy. This leads to inaccurate ideas, such as the idea that an automobile is derived from bolts. This is an unnatural upside-down hierarchy, which does not behave like the natural hierarchy that models how people think. A result of this unnatural hierarchy is computer programs having behavior that is markedly different from what people expect. Thus, inheritance schemes as found in conventional computing environments tend to prevent software engineers from accurately reproducing the algebra of the real-world object being represented.

As can be seen from the above description, object-oriented programming provides many advantages over traditional programming. However, most object-oriented systems retain the deterministic and synchronous nature of traditional languages, and do not employ a new execution model. Furthermore, object-oriented languages are typically implemented using the “compile, link, load and run” paradigm described above, and therefore cannot produce software of a radically different nature from the user's point of view. Most of the advantages of object-oriented programming are only available to the developer of the software, and end users cannot make use of them.

What is needed is a system and method for distributing software in an online environment that facilitates downloading a software application in small pieces as needed instead of in one large chunk, so as to provide greater flexibility and the potential for greater functionality. Requiring software to be distributed in one piece causes programmers to include many features that are only rarely used. A modular approach to software distribution is needed, one that provides each user with the functionality he or she actually uses. What is needed is a way to distribute and redistribute software in component form so that the cycle of buying and upgrading monolithic applications is broken, and the user buys only what is necessary for the task at hand.

What is further needed is a mechanism for representing software so that it can be altered by the user to better suit his or her purposes.

What is further needed is a mechanism for altering programs as they are running, to allow users to add or remove functionality, or to alter the appearance of the user interface. Such functionality would allow users who are unfamiliar with programming languages to alter the program in the form they are familiar with, as a running program.

What is further needed is an execution model that more accurately represents the behaviors of real-world objects.

What is further needed is a software architecture that can be represented in several isomorphic forms, including source code, a small binary file format suitable for distribution online, a flexible user alterable executable form, and a compiled native CPU instruction form.

What is further needed is a software representation that allows software to be written in a computer language by the original engineer, altered by the user while it is running, and transmitted to an entirely different type of machine where it can be viewed or further altered.

What is further needed is a software representation that utilizes real-time compiler techniques to achieve comparable or superior performance to applications built using the monolithic compile, link, load and run paradigm.

What is further needed is a representation of software that facilitates automated techniques of filtering, optimizing, converting of programs so they may be adapted for use in multiple environments, including devices ranging from, for example, cell phones to supercomputers.

What is further needed is a representation of software that enables content to become unified with the program that manipulates it, so that software and content, are representable as different aspects of a unified whole. All content may be provided as interactive content, so that the user can alter or interact with data as needed. Further, if desired, a user interface for performing these interactions can be added and then later removed.

What is further needed is a system and method that takes advantage of compiler technology in a more flexible way, compiling code only as needed on the client machine. What is further needed is a just-in-time compiler that avoids the above-recited limitations and provides improved flexibility in compiling and distributing software. What is further needed is a meta-cyclic programming language that provides sufficiently high-level constructs to allow users and subsequent developers to make meaningful modifications to distributed software applications. What is further needed is an object-oriented programming environment that makes the advantages of object-oriented programming available to end users as well as to programmers. What is further needed is an architecture that facilitates run-time inheritance, so as to allow objects to change their inheritances at any time. What is further needed is a system that removes limitations in the type of real-world algebra that can be represented, so as to improve modeling capabilities.

What is further needed is a system that can optimize code across modules, and enable recompilation on the fly.

What is further needed is a program architecture that provides the advantages of languages such as LISP but avoids their limitations.

What is further needed is an architecture that avoids the limitations of conventional inheritance schemes in object-oriented programming.

### SUMMARY OF THE INVENTION

The present invention addresses the above-described problems and limitations by combining data flow graph representation with message passing and delegation, a stackless execution model, and a real-time compiler technology that assures that performance of the system is comparable to current methods.

In the following description, the system of the present invention is described in terms of combinations of existing techniques, so as to make the implementation understandable to one skilled in the art. However, the invention is not limited by such existing techniques and frameworks, and one skilled in the art will recognize that the invention provides a new system for creating, modifying, deploying, distributing and transmitting software.

The present invention addresses the above-described problems that arise in online software distribution. Online applications have the potential to be larger and more complex than conventional monolithic applications. Large amounts of data and content can be offered along with the distributed software, in order to create a full-service solution. Since online applications must generally be downloaded to be used, it is advantageous to break them down into small modules and special-purpose components so that they can be downloaded more quickly. The present invention provides a new level of modularity that facilitates such componentization.

The present invention extends and integrates the advantages of object-oriented programming with advanced techniques such as actor orientation, data flow, and real-time compiling to enable distributed applications. The present invention thus allows for greater degree of modularity that is preserved from compile time to run time and is therefore available to users as well as developers. The invention also provides a mechanism that allows software to be altered as part of normal use while it is running, thereby improving the accessibility, portability, and flexibility of software.

The invention provides tools for users or developers to build solutions to problems by combining cooperating components, thereby allowing them to avoid buying (and constantly upgrading) monolithic applications. The functionality that is conventionally supplied in a monolithic application is broken down into hundreds or even thousands of components that are distributed and redistributed as needed. Those components can be recombined, added, or removed as needed by the user. The components are selected, downloaded and inserted into an empty template, which itself is a component. These components can be rearranged according to their rendering layers, their temporal ordering, or their response to user interaction. In addition, components can be assembled out of other smaller components. Once joined, they can be saved as a whole, and can later be added to, broken apart, or removed.

The invention provides a scalable user interface paradigm. Components carry their own user interface, so that they can be edited in place. Normally, the user interface is removed before the software or content is distributed. This produces a small component that can be distributed. This component can be repopulated with user interface components, altered, and saved again. When the content needs to change, a user interface is again inserted, then stripped away after the change has been made.

The present invention provides a mechanism for developing and distributing software according to a new model, which provides the following features and advantages:

The invention removes limitations that prevent applications from accurately duplicating behavior of real-world objects.

The invention further makes representation of the execution model explicit. By providing an execution model as one of the isomorphic representations, the present invention makes such a representation available and robust.

The invention further provides optimization across software modules, as well as enabling recompilation on the fly.

The invention further enables the advantages of self-modifying languages such as LISP, while avoiding the limitations of such languages.

The present invention thus provides a new, higher-level representation of software that is still general purpose. The software can be represented in several forms: the traditional computer language form, a highly compressed binary file format, a data graph, and an internal form that executes within the computer. Because the forms are isomorphic, they can be converted back and forth without loss, and various operations can be performed on the representations in any of the various forms.

This allows software to be built up from small components while it is running. Components can be added, deleted or rearranged as the software is running. This allows users to change their software to suit their needs. The present invention permits such changes to be saved for later use or distribution. In addition, a real-time compiler maintains performance levels at or near the same level as conventional monolithic programs.

Finally, the present invention employs delegation rather than inheritance, in order to achieve run-time modularity while avoiding the above-described limitations of conventional inheritance schemes. In a delegation scheme as implemented by the present invention, one object delegates a task to another by sending a message. Delegation thus eliminates the above-described limitations associated with inheritance-based schemes. Delegation allows complex objects to be modeled using natural hierarchies. Furthermore, in a delegation-based scheme as implemented by the present invention, the delegator and the proxy are easily changed at run-time. The confusion as to which object should receive which message, and in what order, is eliminated; the delegator receives the initial message, and passes another message to the proxy. Object encapsulation need not be compromised, and each object can be changed independently without affecting the other.

One example of an implementation of the techniques of the present invention is an Internet-enabled Rich Media System (RMS). The RMS is an example of a commercial-strength web-based distributed application implemented using the techniques of the present invention. One skilled in the art will recognize that many other software applications can similarly be generated using the techniques of the invention.

Software developed according to the techniques of the present invention removes the distinction between the tool used to create content and the content itself. The concepts of software and content are thus unified under one methodology. The invention thus enables end users to perform operations that were previously available only to programmers.

As described in more detail below, the present invention provides an improved self-consistent system for developing and distributing software that provides improved flexibility and enables significant advantages over the prior art.

### BRIEF DESCRIPTION OF THE DRAWINGS

FIG. 1 is an example of a data flow graph.

FIG. 2 is an example of a data flow graph with messages to receptors as solid straight lines, and context messages in curved dashed lines.

FIG. 3 is an example of a data flow graph for implementing a Rich Media System.

FIG. 4 is an example of a data flow graph for applying a combination of graphics transforms.

FIG. 5 is an example of a data flow graph for implementing an equation.

FIG. 6 is an example of a data flow graph for implementing animation.

FIG. 7 is an example of data flow sub-graphs for implementing interactive components.

FIG. 8 is an example of a data flow graph for moving image elements and changing the characteristics of image elements.

FIG. 9 is an example of a user interface for an authoring environment according to the present invention.

FIG. 10 is an example of an animated advertisement that is published from an authoring tool according to the present invention.

FIG. 11 is a flow chart depicting a real-time compiling method according to one embodiment of the present invention.

FIG. 12 is a block diagram depicting compiler operation according to one embodiment of the present invention.

FIG. 13 is a block diagram depicting a system for implementing a data flow graph according to one embodiment of the present invention.

FIG. 14 is an example of a data flow graph.

FIG. 15 is an example of node structure according to one embodiment of the present invention.

FIG. 16 is a block diagram depicting a compiler according to one embodiment of the present invention.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### Graph Representation

The present invention employs a data flow graph to represent content and software. Data flow is based on a metaphor of processing data by passing it through a machine. Whereas hardware data flow systems use physical machines, a software data flow system, such as that of the present invention, creates a pseudo-machine out of software. In the following description, the term “machine” will be considered to apply to such software-created pseudo-machines or virtual machines.

Since real-world problems often require unique solutions, in one embodiment a unique machine is constructed for each application. To facilitate the building of such machines, the data flow architecture of the present invention represents the machines as an assembly of smaller components that can be rearranged as needed. This yields a very powerful way of building up such machines.

In one embodiment, the data flow machines of the present invention are built by establishing connections 102 between primitive machine elements called nodes 101. Each node 101 performs a specific operation on the data as it passes through the node 101. In a data flow system as implemented in the present invention, there can be many different types of nodes 101, each performing a specific task.

The data flow machine can then be viewed as a graph 100; such a representation is well described in graph theory and well known to those skilled in the art. The structure of nodes 101 and connections 102 establishes a topology for the graph. Known principles of graph theory permit data flow architectures to be built with great confidence, robustness, and accuracy.

The data flow architecture of the present invention provides improved flexibility over prior art systems. Data flow graphs can be rearranged into graphs of theoretically unlimited topology and complexity. In addition, any defined portion of the graph can be designated a sub-graph, which can in turn be treated in the same manner as a single node. Sub-graphs can thus have connections 102 coming and going, just like any other node 101. Modularity is thus enforced and enabled by the architecture itself. Large graphs can be assembled out of smaller ones, in a structure that is defined as needed by the developer. Data flow graphs that solve complex problems are relatively easy to assemble. The present invention makes it easier for developers to build software this way because much of the detailed programming is handled inside the nodes 101.

The data flow system of the present invention thus operates like a high-level declarative programming language, providing a mechanism for designing and building programs for solving complex problems.

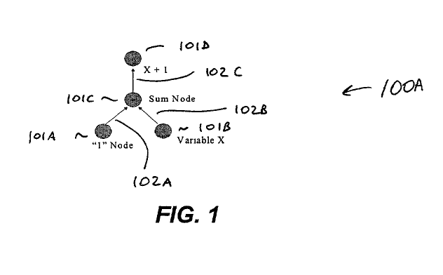

Referring now to FIG. 1, there is shown an example of a data flow graph 100A. The data flows upwards from a constant number node 101A and a variable node 101B (designated as Variable X) into a sum node 101C. The data leaving the sum node 101C is then given as X+1 to node 101D. Connections 102A, 102B, and 102C define the topology of graph 100A.

Graph 100A may be thought of as describing a machine. The particular machine defined by graph 100A processes as much data as is passed through it, always performing the same operation: X+1. Graph 100A does not reveal how often or how much data will pass through it. Such factors would, in general, be determined by surrounding graph elements in a larger data flow graph that may incorporate graph 100A as a subcomponent.

### System

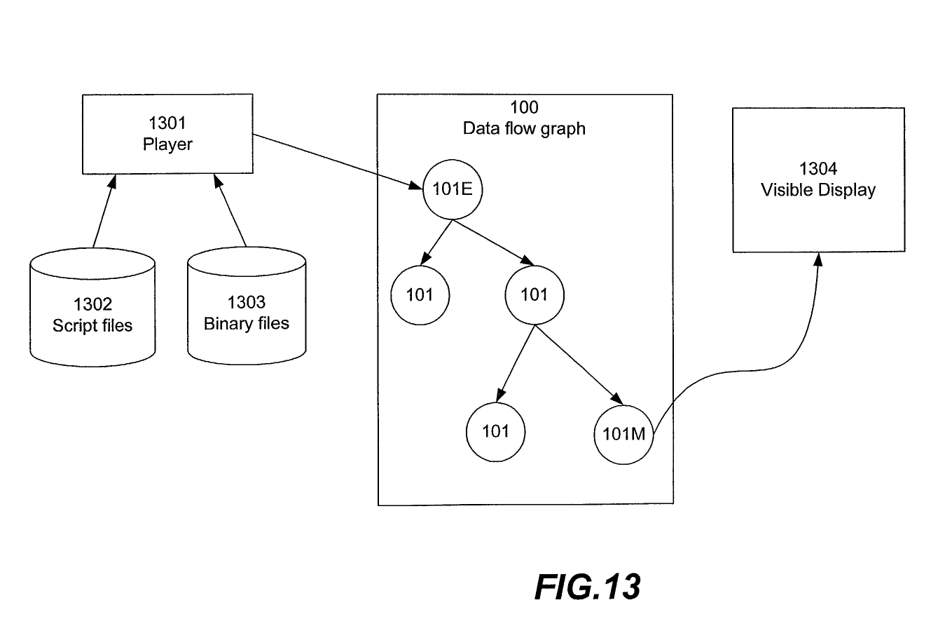

Referring now to FIG. 13, there is shown an example of a system for generating an executing data flow graphs 100 according to one embodiment of the present invention. Player 1301 may be a media player, implemented for example as a browser plug-in or standalone application that runs on a client computer. As described in U.S. patent application Ser. No. 09/429,853 for “Online Focused Content Generation, Delivery, and Tracking,” filed Oct. 28, 1999, the disclosure of which is incorporated herein by reference, player 1301 receives scripts and binary data for presenting sophisticated and engaging content, including animations, interactive content, audio, video, and the like, and presents such content to users. Player 1301 obtains scripts 1302 and binary files 1303 from local storage or from a remote source such as a server attached to a network (not shown). In an environment where player 1301 displays content that is provided via the Internet, scripts 1302 and binary files 1303 may be obtained from a remote server in response to client requests.

Player 1301 generates data flow graph 100 in accordance with scripts 1302 and binary files 1303. Data flow graph contains nodes 101, including executive node 101E (described in more detail below), and image node 101M (described in more detail below). Image node 101M provides the final image (either static or animated) that is drawn on a visible display 1304 such as a display screen, on-screen window, and the like. As is known in the art, visible display 1304 may be implemented as a frame buffer, or portion thereof, for controlling visual output of a computer system.

### Object Oriented Data Flow

In one embodiment, graphs 100 are implemented in a computer system using well-known techniques of object-oriented programming. Each node 101 in the data flow graph 100 is implemented as an object, in the sense used in object-oriented terminology. Connections 102 of graph 100 are implemented as references to other objects. The messages contain the data that flows through the system represented by graph 100.

In one embodiment of the present invention, there are no restrictions on the topology of graph 100. All objects and nodes 101 in the graph thus support all possible messages. That is, all nodes 101 represent mutually polymorphic objects—they are different objects but can support identical interfaces.

By providing polymorphic objects in this manner to construct data flow graphs 100 with a high degree of flexibility, the present invention combines attributes of object orientation and data flow techniques to provide a system for generating highly adaptable and powerful software code.

In one embodiment, graph 100 is constructed from received data, including for example script data, binary data, images, fonts, and the like. Graph 100 is constructed in a sequential manner, by starting at the top and descending down graph 100, creating nodes 101 of the correct type as specified in the script data, and attaching each created node 101 to the appropriate parent nodes 101. In one embodiment, nodes 101 are created using a CreateNode operation that specifies where a node 101 should be added and defines its parameters. Connections among nodes 101 are established via a SetAttribute message that is sent to the object reference representing the node 101. The SetAttribute message may also be used for other purposes, and in general specifies which attribute is to be set as well as the object reference of the node 101 to use.

As graph 100 is created, nodes 101 and sub-graphs are defined and given names. Names can then be used as attributes of nodes 101 as they are created.

### Actor-Based Systems

In one embodiment, the present invention implements actor-based systems based on the topology defined by data flow graphs 100. Actor-based systems (also called Asynchronous Message Passing Systems) extend object-oriented programming and provide additional functionality for distributed, multi-processor, parallel applications across networks.

In an actor-based system as implemented by the present invention, each object, or actor, can send and receive messages from other actors; when a message is sent from one actor to another actor, there is no requirement that the message recipient return to the sending actor. In fact, a return value, if appropriate, comes in the form of a separate message. Actor-based systems running on a single machine require no pushdown execution stack and operate purely by this message-passed technique. Additional characteristics of actor-based systems will be known to those skilled in the art.

As an execution model, actor-based systems offer substantial benefits over conventional computer languages (such as C, C++, LISP, and the like), which typically use an execution model based on a subroutine execution stack. Actor-based systems assume that each node is operating asynchronously to all the others. Thus, each node could operate on a distinct thread, or in distinct processes, or even on different machines. Actor-based system architectures are therefore highly flexible and generalizable, making them ideal for implementing distributed and concurrent applications. In particular, in an actor-based system, a message can be sent at any time from one node to another, and the receiving node will respond when it gets a chance.

Accordingly, by contrast to conventional systems as described above, the present invention does not require an execution stack and can therefore function more easily across multiple machines and processes. Conventional difficulties in sharing context represented by execution stacks are thereby avoided. Synchronization mechanisms that rely on sharing execution stacks, and the complexities associated with such mechanisms, are similarly avoided.

The hyper-modularity of the present invention allows any sub-graph to be separated out and distributed to any number of machines, or concurrently executed by any number of processes or threads.

In one embodiment, the present invention combines an actor-based execution model with the object-oriented data flow techniques described above. The resulting system provides a unique approach to implementing general-purpose software systems. In addition, in one embodiment the present invention employs delegation rather than inheritance, so as to facilitate building up more natural systems.

### Isomorphic Representations

In one embodiment, the present invention provides several representations of software. Each of the representations is isomorphic to one another; that is, a one-to-one correspondence is maintained among components and their behavior, and representations can be converted back and forth between each other without any loss of information. Thus, rather than compiling source code to derive machine-readable object code (which in general cannot be converted back to source code and therefore is non-isomorphic), the present invention generates software that can be translated and converted freely among various representations.

One representation is the executable form of a graph 100 in memory. Each node 101 includes data and code to properly implement the behavior of the node 101.

The second representation is a scripting language. A scripting language is used to write pieces of content or software by hand. Any properly formed script can be converted to the executable form, and back again.

The third representation is a highly compressed binary file format. The binary file format is isomorphic to the script and the executable form. For every construct in the script there is construct in the file format.

In one embodiment, there is a perfect one-to-one correspondence between constructs in each representation, so that the isomorphism of the representations is maintained.

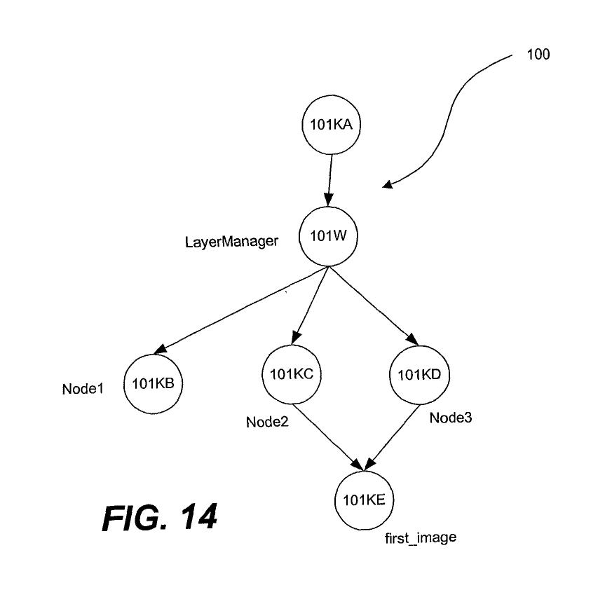

Referring now to FIG. 14, there is shown an example of a data flow graph 100 that illustrates isomorphic representations. Data flow graph 100 includes a number of nodes 101, including a LayerManager node 101W, a first_image node 101KE, and three nodes designated Node1,Node2, and Node3 (101KB, 101KC, and 101KD respectively). The following human-readable script excerpt provides an example of an alternative representation that is isomorphic to the graph 100 shown in FIG. 14:

<Image

ID = first_image
Data=“file”

/Image>
<Executive

Source = <LayerManager

Source = <Node1>
Source = <Node2

Source = first_image

/Node2>
Source = <Node3

Source = first_image

/Node1>

/LayerManager>

/Executive>

The following is an example of the internal structure of the tagged binary format that provides another representation that is isomorphic both to the graph 100 shown in FIG. 14 and to the above script excerpt:

BeginImageNode
IDAttribute
<‘first_image’>
DataAttribute
<image data>
EndImageNode
BeginExecutive
SourceAttribute
BeginLayerManager
SourceAttribute
BeginNode1
EndNode1
SourceAttribute
BeginNode2
SourceAttribute
<‘first_image’>
EndNode2
SourceAttribute
<‘first_image’>
EndNode1
EndLayerManager
EndExecutive

All three forms, including graph 100, the script, and the tagged binary, are platform independent, although the precise details of the tagged binary may vary depending on the particular machine on which the code is running.

Another form is the visual output seen by the user. This is the ultimate result of the process embodied by the other three forms, and is preferably identical across all platforms.

In the present invention, the internal graph form exemplified by FIG. 14 is the primary form. The script and binary file are translated into the graph form, and are then output in whatever form necessary for a particular operation.

### Distributed Applications

The present invention facilitates the creation of online distributed applications. In the context of the present invention, a distributed application is a software application that runs cooperatively on a number of machines. The present invention allows software to propagate from machine to machine across platform types, yet retain its essential features.

The client/server model is one type of distributed application known in the art. Software that conventionally would be installed on the user's personal computer is instead implemented on a server. Applications that require access to large amounts of data, such as a database, are often implemented using a client/server architecture. Software is located on a single centralized computer, so that it can be maintained and operated properly. The software can be updated in a single location, and all the clients automatically get the benefit of the update.

The present invention facilitates a new paradigm wherein traditional applications are hosted on a central computer and are utilized component-by-component by downloading them to the client. The client can alter the downloaded components in a variety of ways and can also add them back to the server. The altered components can then be redistributed again to other clients. Because the data is unified with the software that displays it and the user interface that manipulates it, the software can travel from peer to peer and across multiple servers. The present invention thus improves and extends the conventional client/server model.

In a distributed environment as enabled by the present invention, applications can combine access to data and large amounts of content, along with the software to view and manipulate them.

In one embodiment, the invention generates distributed applications by assembling content from various parts. Each part can operate on its own, or can be integrated into a larger whole. In the context of data graphs 100 as described above, any sub-graph can function by itself and without reference to other portions of the larger data graph 100. In on embodiment, a sub-graph must be under an executive node 101E to function, although such a requirement may be omitted and is not necessary to practice the invention. By allowing components such as nodes 101 and sub-graphs to operate independently, the present invention facilitates the creation of software code which is modular and which can function as it is being put together.

In one embodiment, software components, representable as nodes or sub-graphs, can operate inside a viewer/selector window, while the same components can run inside a content authoring application. These two functions can take place concurrently, for example in two different execution threads.

As the program embodied by the software components runs on one machine, it can be altered or can alter itself. That altered form can then be sent to another machine where it can be further altered and sent. The polymorphic nature of nodes 101 according to one embodiment of the present invention facilitates such alteration without risking the possibility that the resultant code will not function properly.

Some nodes 101 can communicate with servers or other machines. In one embodiment, such communication is performed by sending data from the client back to a server, or receiving data from the server. For example, a node 101 could connect to a server to receive streaming stock market data, which is then transmitted via data connections to other nodes 101 that display or modify the received data accordingly.

### Computing Paradigm

The present invention provides an improved paradigm for generating and distributing software that combines the above techniques so as to achieve the previously-described goals within a simple, small, high-performance and easy-to-use system. The following description of the invention is presented in the context of a Rich Media System, though one skilled in the art will recognize that other implementations and applications are possible.

The present invention employs object-oriented data flow graphs 100 extended by an actor-based execution model to represent both software and content. Many different types of nodes 101 are provided, each with a distinct purpose. In addition, each node 101 accommodates a number of connections 102 to other nodes 101.

Each node 101 is implemented as an object; its data is encapsulated, and it receives and sends messages. In one embodiment, messages are sent and received along the connections 102 of the data flow graph. One node 101, designated the source node 101, sends the message to another node 101, designated the receptor node 101, which may turn send other messages to other receptors.

In the present invention, encapsulation is taken to a very high degree. In particular, nodes 101 do not directly share data with other nodes 101, and their behavior is independent of their sources and their receptors. The behavior of the overall system is built up by nodes 101 delegating tasks to other nodes 101.

In one embodiment, a node 101 delegates a task to another node 101 by sending a message to another object. The delegator establishes a context, including the arguments of the message, and jumps to the object reference corresponding to the delegatee. In one embodiment, the delegating operation causes nothing to be pushed on the execution stack. Tasks are thereby pushed down the connection chain in graph 100. When a terminal or leaf node 101 is reached, a message of “continue” is sent back up the connection chain to the established context; the context then continues execution.

In another embodiment, the invention may be implemented using subroutine calls to send the messages. Thus, the invention may be implemented in a simplified form using an existing computer language.

The present invention facilitates a degree of hyper-modularity that goes beyond the object modularity provided by conventional architectures. Modularity is a well-known concept in software development; it provides a mechanism for breaking problems into smaller tractable sub-problems, and for providing flexibility in assembling applications. Conventional “compile, link and run” applications are only modular at development time. During compilation, the modularity is stripped out by the compiler and linker to create a monolithic application. Some applications allow for plug-in modules, but in general such plug-ins offer a limited degree of modularity. Some interpreters preserve modularity so that it is visible at run-time, but most do not allow restructuring of a program while it is running.

The present invention facilitates hyper-modularity. The content or software remains in identifiable components while it is running, and those components can be rearranged while the program runs, and can further be saved, removed or passed along to other users. In one embodiment, the invention provides this high degree of modularity by defining functionality in terms of data flow graphs 100. All nodes 101 in graphs 100 are polymorphic to one another, allowing arbitrary replacement without adverse effects such as crashes, halts, and the like. Connections among nodes 101 are similarly defined by other nodes, so that graph 100 topology can be rearranged on the fly in the same manner as any other node 101 modifications are made. The invention allocates and manages memory in a modular way so that rearrangement and reconfiguration of nodes 101 and connections cause no leaks or loose pointers to data.

The hyper-modularity of the present invention allows operations such as the following:

Inserting or removing a user interface from content.

Saving part of a graph for use later.

Combining modules together without concern about their compatibility.

Optimizing content by rearranging the topology, replacing nodes 101, and/or removing nodes 101.

Rearranging the graph while it is running, thus essentially allowing software to be rewritten while it is running.

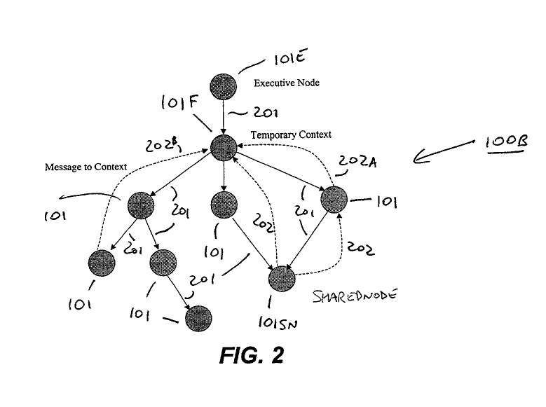

Referring now to FIG. 2, in one embodiment, one node 101 in each graph is designated the executive node 10E. Messages begin at this node 101E and travel from there throughout graph 100. In one embodiment, the executive node 101 is the only node 101 that is a source but not a receptor. Topologically, all nodes 101 in graph 100 are n^{th}-generation receptors of this node 101.

In one embodiment, when a message arrives at a node 101, the node 101 becomes active, makes changes to its internal state variables as appropriate, and sends out messages to other nodes 101. Each node 101 is encapsulated; it knows nothing about the inner workings of other nodes 101, or about the relative node 101 positions in graph 100. The execution model of the present invention is therefore distributed throughout the entire graph 100.

The present invention avoids endless loops or cycles by one of three methods. In one embodiment, cyclic topologies are prohibited, so that only acyclic topologies may be constructed. In another embodiment, cyclic behavior is avoided by a “Hansel and Gretel” method—if a previously encountered node 101 is reached a second time, execution flow simply terminates the message.

A third technique for avoiding endless loops is to require the identity of messages to change each time the direction of message-passing changes; that is, away from or towards the executive. The message is demoted until there are no messages to demote to. For example, a Render message that indicates a node 101 should draw itself is sent back towards the executive node 101 as a Paint message. A Paint message can never cause a new Render to happen, and eventually execution completes.

In one embodiment, these operations and responses are enabled by permitting nodes 101 to have access to a context node 101F that forms part of each message sent to each node 101. Context node 101F defines the context in which the message is to be processed. Accordingly, if a node 101 needs any information or methods that are not available within its own encapsulated form, it requests the needed item from the context node. Context node 101F essentially performs the role of an operating system for the node 101. Because the execution stack is not used, similar functionality is distributed over all the nodes 101. Each node 101 keeps automatic memory inside itself, instead of on the stack. The context replaces the place to which execution flow returns, as well as replacing the operating environment.

A context node 101F is an object reference like any other, except that it is higher up on the data flow graph 100 than other object references. Messages sent to context node 101F are essentially identical to those sent to any other node 101.

A node 101 can be implemented as a standard data structure. The data structure contains object references that specify the attributes (or child connections) of the node 101. In addition, the node 101 may include storage locations for storing temporary values and/or variables. Thus, nodes 101 can maintain such values without saving them on a stack as is conventional in the art.

In one embodiment, any node 101 can become the context node 101F for all its subordinate, or receptor, nodes 101. The receptor nodes 101 can then obtain information from the context node when needed. The invention thus provides an environment analogous to several layers of virtual operating systems. Typically, a node 101 that becomes a context node does not try to do everything itself; rather it delegates some functionality and/or data to its own context. For example, when a message arrives at a particular node 101, its path can be traced backward through the graph to the executive node 101. A message sent to the context node will be addressed to one of the nodes 101 along that path. However, there may be many paths to a node 101, as shown in the example of FIG. 2.

Data flow graph 100B in FIG. 2 includes messages 201 to receptors as solid straight lines, and context messages 202 in curved dashed lines. Executive node 101E is the source of messages 201 that travel among other nodes 101. Shared node 101SN has two different contexts based on the path taken to it. Shared node 101SN exemplifies the property of nodes 101 that allows a node to appear twice in different contexts. For example, a context may have two or more translations; if shared node 101SN is visible, it can appear in two places on graph 100, once for each translation.

Shared nodes 101SN save memory. For example, in a system for rendering particle-based animations, the same node 101 (or even an entire sub-graph) may appear hundreds or thousands of times. By implementing such a scheme using shared nodes 101SN, significant memory savings can be achieved.

The present invention provides additional advantages over the prior art by, in one embodiment, enforcing certain rules about the behavior and characteristics of nodes 101 and messages 201 and 202.

The first rule is that any node 101 can connect to any other node 101, regardless of topology or the species of the two nodes 101. Any species of node 101 can be substituted anywhere in a graph 100, and the graph 100 will still behave correctly. The topology of the graph 100 can be rearranged arbitrarily without loss of integrity. Such changes will not cause the program to crash or get caught in a cycle, and will not adversely affect the behavior of other areas of the graph.

In one embodiment, graph 100 topology is changed by sending a SetAttribute message to a node 101 specifying an attribute (i.e., which connection is to change) and its new node 101. All attributes begin as references to a Null node and are changed by the SetAttribute message. Such a scheme ensures that the graph 100 is always valid and remains valid. In one embodiment, all internal graphs 100 and sub-graphs are modified this way, even when reading binary and script files. Although this scheme ensures a valid graph 100, the graph 100 may not necessarily be what the author intended. However, the author can be assured that the graph 100 will not crash or get caught in infinite cycles.

The second rule states that whatever messages 201 and 202 can pass between two nodes 101 must also be able to pass between them when the nodes 101 are reversed. That is, no node 101 can send a message 201 and 202 another node 101 cannot receive, and visa versa. Therefore, all nodes 101 are able to send and receive the exact same set of messages 201 and 202; in object-oriented terminology, they are all mutually polymorphic classes.

These two rules enforce strong limitations on the way object-oriented methodology is implemented in one embodiment of the system, so as to achieve the improved flexibility described above.

The architecture of the present invention is a uniform, highly structured way of making programs, and therefore has many of the properties of a computer language. However, the present invention is not limited to any particular syntax, as would a conventional computer language. Programs generated according to the present invention can be represented in a variety of different forms, such as for example: raw ASCII script; binary file format (referred to herein as an OFB file); or an internal graph form. These various representations are isoforms of each other, meaning that they can be converted back and forth without loss of information. The present invention thus facilitates generation of programs that can have more than one standardized form.

The present invention provides an application framework that is above the level of conventional high-level languages. The primitives in the system of the present invention contain more significant amounts of code and data than primitives in typical computer languages, and are more powerful than those of conventional languages. Conventional languages typically define primitives such as integers, floating point numbers, subroutines, and the like, and object-oriented languages add classes and inheritance mechanisms. However, these levels of abstraction are generally too low to be of use to end users. The present invention provides hyper-modularity to the end user at a higher level. These modules, or nodes 101, are well-engineered objects that manage their own memory, system resources, error handling, birth, and death. Complex algorithms are encapsulated within nodes 101, rather than exported as primitives that need to be managed by users. Combined with the inherent integrity of the graph, the level of flexibility of the system is comprehensible and practical in a commercial application.

The use of the system is simplified further by collecting primitive nodes 101 into sub-graphs. Thus the system can be fully broken down into primitives. This improved flexibility permits the boundaries defining modules to be redrawn in a variety of ways.

### Nodes 101

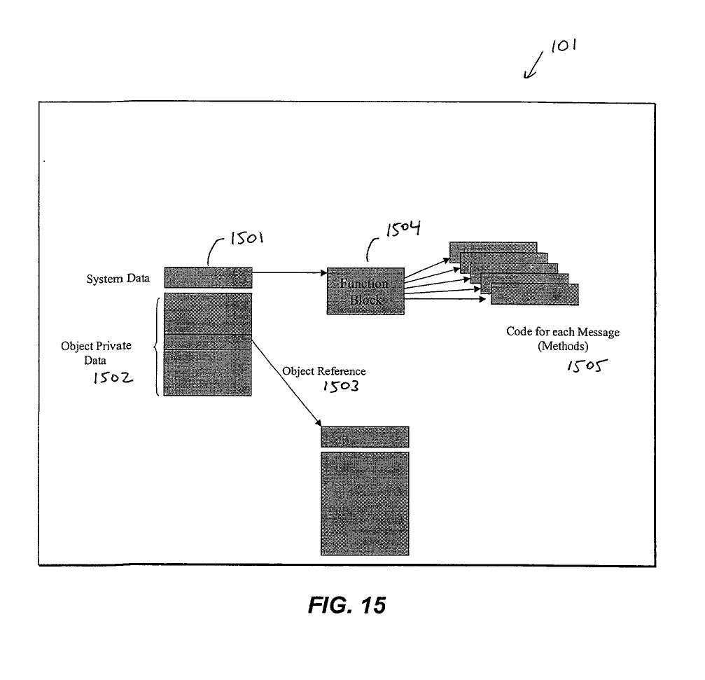

Referring now to FIG. 15, there is shown an example of node structure according to one embodiment of the present invention. One skilled in the art will recognize that any structure can be used for creating and maintaining nodes 101. The interior structure of a node 101 is in general irrelevant to the outside world, since encapsulation shields the interior structure from view. In one embodiment, as shown in FIG. 15, node 101 is implemented as a typical object, where subroutine calls are replaced by jumps, and where every object belongs to the same class. Accordingly, node 101 includes system data 1501 for maintaining data related to system functions, object private data 1502 for maintaining data that is internal to node 101, object references 1503 for pointing to and interacting with other nodes 101, function block 1504 for controlling the actions of methods and messages, and code 1505 for each message or method defined in node 101. The operation of each of the components of node 101 is similar to the operation of a corresponding component in a conventional object, as will be apparent to one skilled in the art.

### Real-Time Compiler

In one embodiment, the present invention provides improved flexibility by avoiding monolithic compilation as it is performed in conventional programming environments. Performance is improved by employing a real-time compiler, which is implemented as an aggressive version of a Just-In-Time (JIT) compiler. The real-time compiler compiles code just before the code is to be executed. This allows code to be changed “on the fly,” so that the real-time compiler can be used in a system with the flexibility of the system described above.

The real-time compiler assembles native instructions in about the time it would take an interpreter to pass through once. However, the routine may itself be a loop executed many times. For example, a pixel rendering routine is compiled once, but is executed for each pixel, perhaps millions of times. Thus, a real-time compiler can achieve a significant measure of improved performance.

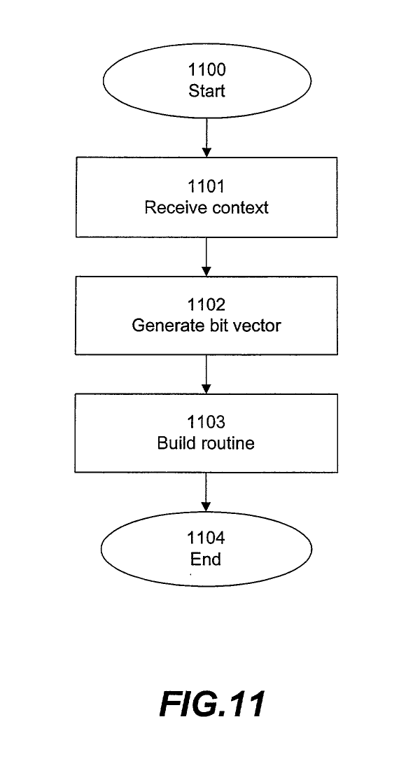

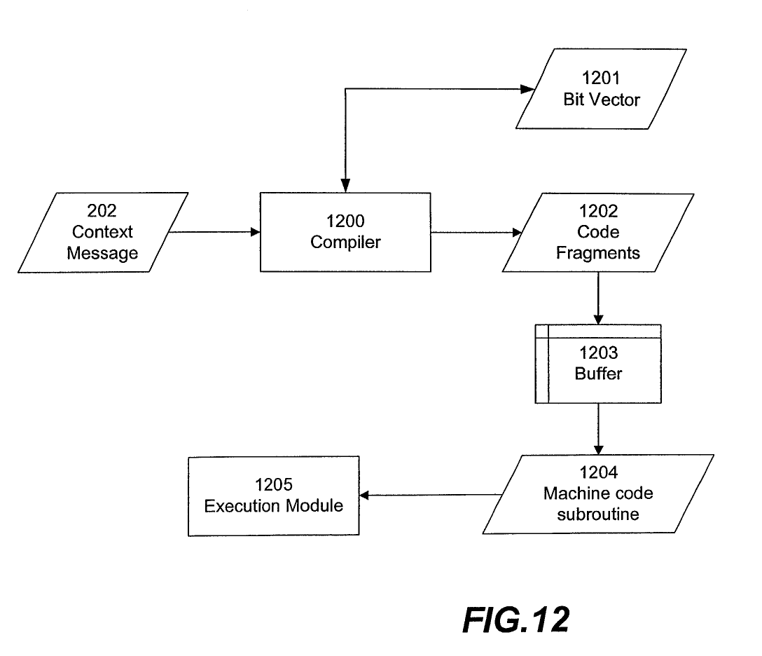

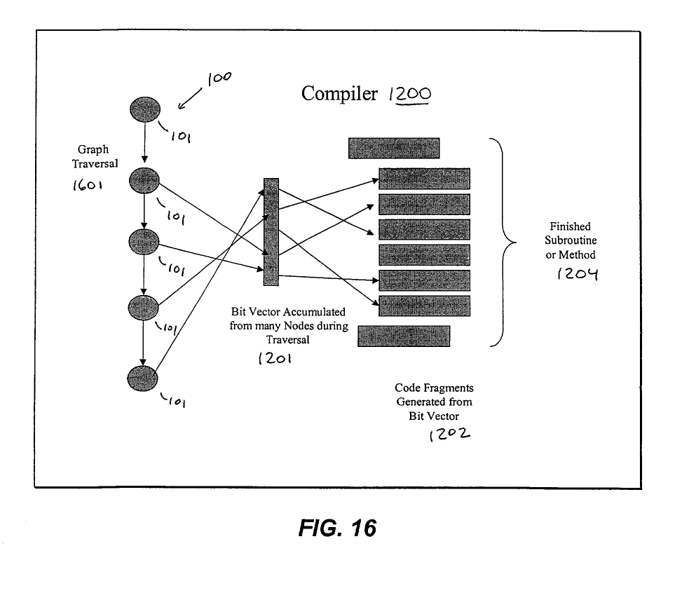

Referring now to FIG. 11, there is shown a flow chart depicting a real-time compiling method according to one embodiment of the present invention. Referring also to FIG. 12, there is shown a block diagram depicting compiler operation according to one embodiment of the present invention. Referring also to FIG. 16, there is shown a block diagram depicting a compiler 1200 according to one embodiment of the present invention. Real-time compiler 1200 receives 1101 context message 202 after it has passed through a series of nodes 101 via a graph traversal 1601 operation. This aggregated information is coalesced 1102 into a single number, referred to as a bit vector 1201, that describes a subroutine. In one embodiment, bit vector 1201 contains 32 bits, thus providing unique identifiers for over four billion possible subroutines.

Using bit vector 1201, real-time compiler 1200 builds 1103 precisely the right routine for the task at hand. In order to optimize the end result, any operation that is not needed is excluded from the compilation operation. For example, if a pixel can be rendered with an intensity factor, but the factor is 1.0, the multiply operation can safely be omitted from the compiled code. Similarly, if the factor is 0.0, a constant color of black can be rendered in place of the source pixels. In one embodiment, the compiler builds 1103 the routine by allocating memory for code as it would for data. The bit vector generated in 1102 guides the compiler to insert small code fragments 1202 into buffer 1203. Once the process is complete, buffer 1203 contains pure machine code subroutine 1204 that can be called by any execution module 1205, such as one running C, for example.

In one embodiment, bit vector 1201 reorders code fragments 1202. The order in which nodes 101 are encountered may not matter in graph 100, but may be significant in the final code 1204.

The types of routines and operations readable by compiler 1200 are not conceptually limited. In an alternative embodiment, each node 101 generates its own code fragments 1202 instead of setting bit vector 1201, and compiler 1200 merely reorders them. Then, as new nodes 101 are added to graph 100, each new node 101 brings its own code fragment 1202 generator.

Typical compilers first translate human written code into a graph structure representing the code. The final pass of the compiler traverses this graph generating the final code 1204. This invention uses graph 100 as the human written form directly and generates code 1204 according to known techniques. However, the graphs 100 presented by the present invention are composed of much more powerful and useful nodes 101, in effect extending the concept of a compiler-generated graph to a new level.

On some platforms, the operating system (not shown) is informed that the target memory block is to be executed.

By compiling using the above-described technique, compiler 1200 operates using machine code, which yields code that executes up to two to three times faster than compiled C code. In addition, machine code 1204 can make use of special hardware not available in C, such as MMX instructions, special registers, and the like.

In addition, routines can be tuned to the exact hardware. The compiler generates code tuned for the capabilities of the host machine. For example, MMX may not available on all CPUs, so the compiler can take this into account when generating code. This principle can be extended to a variety of machine properties. Tests for special cases during execution can be eliminated, so that only the exact code required is generated.

Because the bit vector is generated each time a routine is called, the invention is capable of responding to changes in real time. For example, if the intensity changes from 1.0 to 0.9, a new routine can be generated that includes the intensity calculation. Therefore, during an animation, the system of the present invention may generate new code as attributes change.

Since there may be a large number of possible routines, most of which are rarely used, creating all of them at startup would consume unnecessarily large amounts of memory and time. Accordingly, the present invention generates routines on the fly and saves them for re-use. Some routines (for example, the N most recently used routines, where N is some number such as 1,000) are kept in a hash table and are saved for reuse. In one embodiment, since the bit vector uniquely identifies the routine, the bit vector operates as the hash key.

The above-described compiler techniques provide improved speed and efficiency, and provide a number of advantages over conventional techniques for compiling and linking software code. Specifically, according to the present invention each routine is created for the particular situation at hand, so that any code that is not needed is eliminated. The compiler techniques described above allow shortcuts to be taken that are not practical in traditional architectures, thus further improving performance and eliminating unnecessary processing and execution.

Compiler 1200 can take advantage of low-level instructions such as MMX, and can even generate special code for the particular machine platform. For example, the compiler can easily be made to generate code for the particular MMX version on which the client is running.

The invention further avoids generation of general-purpose routines where possible. Thus, other short cuts can be used which take advantage of special-case situations. In particular, the invention is able to tune the computed precision to the situation.

The invention further improves performance by generating highly optimized fixed-point code that is generally impossible to achieve in conventional high-level languages such as C.

Accordingly, the present invention uses the above-described techniques to gain speed without sacrificing flexibility.

### EXAMPLE

### Rich Media System

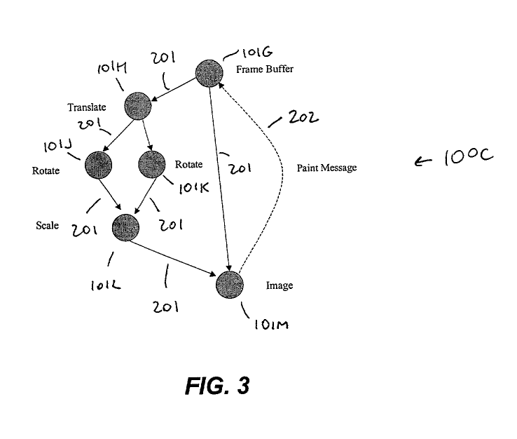

Referring now to FIG. 3, there is shown an example of data flow graph 100C for implementing a Rich Media System (RMS) according to one embodiment of the present invention. RMS provides functionality for creating graphics, sound, special effects, interactive content, user interfaces, animation, games, interactive content and related software. It is also designed to support an online application for content creation and management.

One skilled in the art will recognize that the following description of RMS is merely exemplary of how the above-described architecture can be applied to build a useful and hyper-modular system for solving real-world problems.

In RMS, there are three types of image nodes 101, each of which can contain an unchanging image or can be re-rendered every frame.

RgbaCache, a 32 bit true color image with alpha channel.

MaskCache, an 8-bit image with a Lookup Table (LUT).

CoordCache, a 32-bit image that contains an (x,y) vector at each pixel. These nodes 101 encapsulate pixel memory and rendering operations specific to their type of image.

Each of these nodes 101 responds to three-dimensional spatial transformations from nodes 101 above them. The following nodes 101 establish state within the context for transforming images nodes 101.

MoveBy, move by a specified 3D vector distance.

MoveTo, move to a 3D position, overriding the accumulated transform.

AxisScale, scale x y and z by different scale factors.

RotateBy, accumulate a 3D rotation of an angle around an arbitrary axis.

RotateTo, rotate to a specified angle around an axis.

Perspective, cause the image rendered in perspective.

Traditional 3D hierarchy is thus mapped onto data flow graph 100 in a unique and useful way; the same object can be drawn with a different position, depending on multiple paths taken to the node 101.

FIG. 3 shows three message paths to a single image node 101M. Each of the paths passes through a different set of spatial transforms, which are used to render the image in different positions. In this embodiment, a render message descends to image node 101M by three different paths, causing the image to Paint itself three separate times, each with a different location and orientation.

The transformation nodes 101H, 101J, 101K, and 101L use vector and scalar values. Several types of nodes 101 are available that represent simple mathematical objects.

Vector takes three scalars, x, y, & z to create a 3-vector.

Vector Constants are specified as three numeric constants (1, 2, 3).

Animation is accomplished using nodes 101 that change in time.

Interval takes two numbers, vectors or colors and animates on the line between them. There are several nodes 101 that control how the animation behaves over time.

Spline takes four numbers, vectors or colors and animates on the spline between them. There are several nodes 101 that control the exact form of spline and animation.

Sequence allows any number of animations to be applied sequentially. Different types of animation can be stitched together in time using the sequence node 101.

The following nodes (not shown) control other attributes of image rendering.

LayerManager controls the rendering order of any number of images.

Composite alters the compositing mode of the image

Contrast alters the intensity and offset of any image beneath it.

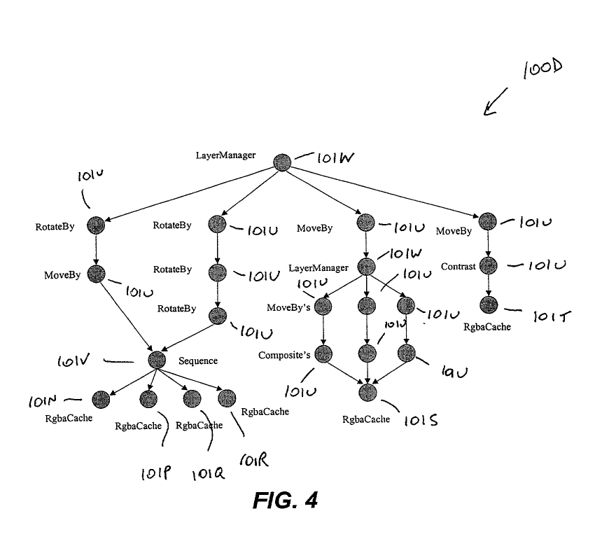

Referring also to FIG. 4, there is shown a graph using some of the nodes described above. It displays six images based on nodes 101N, 101P, 101Q, 101 R, 101S, and 101T, with various spatial transforms and rendering attributes specified by various nodes 101U. There is also a Sequence node 101V that specifies an image sequence. The ability to arbitrarily rearrange a graph such as 100D is an extremely powerful feature. LayerManager nodes 101W control the application of modifications to other nodes 101: while a node 101 outside a LayerManager 101W modifies all the layers, a node 101 inside the LayerManager node 101W modifies only the layer it is on. LayerManager nodes 101W can be inside other LayerManager nodes 101W.

In one embodiment, LayerManager node 101W is implemented as a simple node 101. It is an ordered list of attribute nodes 101. Any message sent to the LayerManager node 101W is simply delegated to its child or attribute nodes 101 in the specified order. One exception is the SetAttribute, which is used to set attributes, delete them, replace them, or reorder them.

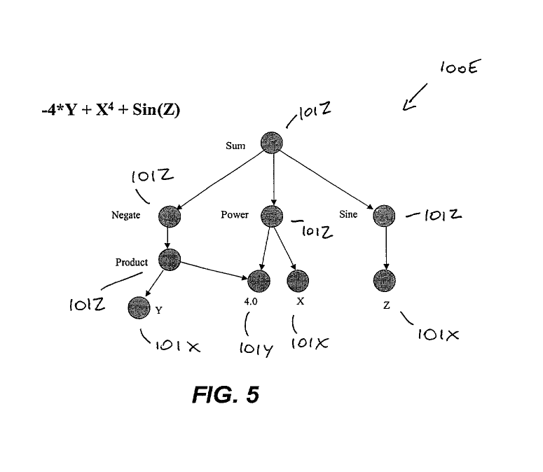

Referring now to FIG. 5, there is shown an example of a data flow graph 100E for implementing an equation. In one embodiment, nodes 101 may be provided for implementing equations, In statements, and the like. Equations can be built up from mathematical nodes such as Sum, Product, Max, Min, Average, Subtract, Divide, Greater, GreaterEqual, Less, LessEqual, Power, Reciprocal, Negate, Square, SquareRoot, Modulus, Sine, Cosine, Tangent, ArcSine, ArcCosine, Arctangent, and the like. Each of these takes input from other nodes and generates as output a value corresponding to the specified mathematical operation.

In graph 100E, nodes 101X represent variables that can, for example, be provided via messages from other sources. Node 101Y represents a constant. Nodes 101Z represent mathematical operators that generate output based on the input that is provided.

Graph 100E may be treated as a sub-graph that can replace any number node anywhere in a larger graph 100. The equation embodied in graph 100E can also be turned into an animated equation by replacing any of the number nodes 100X or 101Y with a node that generates a changing value with time, such as an Interval or Spline. In one embodiment, mathematical nodes 101Z work as well on vectors and colors as they do on simple scalars.

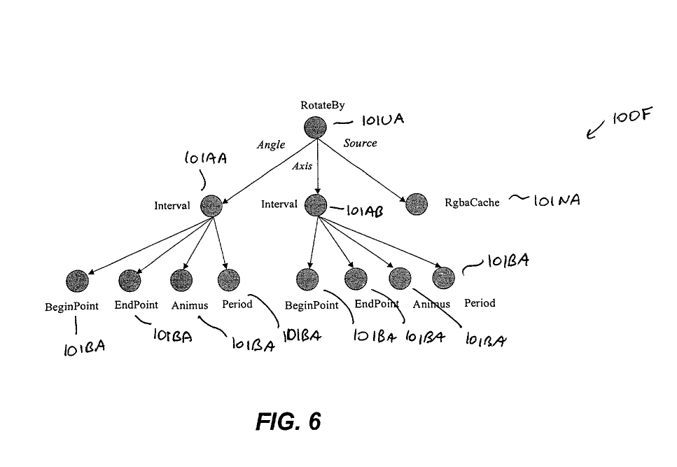

Referring now to FIG. 6, there is shown an example of a data flow graph 100F for implementing animation. Here, RotateBy node 101UA obtains the angle and axis of rotation from two different Interval nodes 101AA and 101AB. These in turn obtain their BeginPoint, EndPoint, Animus, and Period from other nodes 101BA. Nodes 101BA are drawn as single nodes, but could be implemented as equations, further animations or even user-driven interactive nodes. The source image is drawn from node 101NA

The invention is also able to generate procedural images. This includes gradients, shape blends, radial and sweep patterns and various noise functions. This is done, partly, by implementing animations as functions of space instead of time. Equations can also be used to combine various procedural techniques.

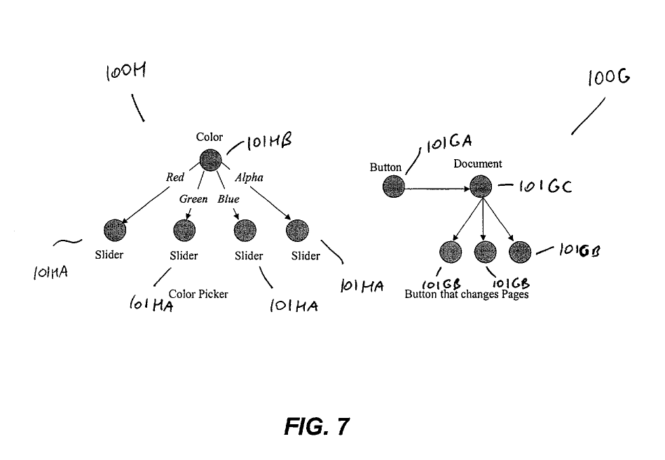

Referring now to FIG. 7, there is shown an example of data flow sub-graphs 100G and 100H for implementing interactive content. According to the present invention, functionality such as the user interface, games, and interactive content can be implemented using graph topologies with interactive nodes. Interactive nodes include, for example:

SwitchBox: A collection of pages, only one of which is active at a time. The current page can be changed via message from another node 101.

Document: Exactly like a SwitchBox, except that time is reset to zero at every page change so the animation on a page starts over after a page change.

Button: A button has three states—Idle, Over, and Select. It changes states on a mouse rollover and on a mouse button click. The button click can send messages to other nodes 101.

Slider: A slider can replace any number node 101. It has three states—Idle, Over, and Select. The slider changes states on a mouse rollover, and the knob tracks the mouse while the mouse button is held down. The knob tracks linearly between two points and returns a number between the begin and end values.

Drag: The Drag node 101 is just like a slider, but it travels freely in two dimensions and replaces a vector.

FIG. 7 illustrates two sub-graphs 101G and 101H that use interactive components to manipulate ordinary nodes 101. Sub-graph 100H shows four slider nodes 100HA controlling the four channels of a color node 101HB. Sub-graph 100G shows a button node 101GA controlling the page nodes 101GB of a document node 101GC. The page nodes 101GB can in turn represent sub-graphs of any size that are switched in and out of the active part of sub-graph 100G at the discretion of the user.

In one embodiment, RMS supports many other nodes 101, including for example:

FontManager: Loads fonts for use by the Text node 101.

Text: Renders a string of text. The glyphs can be any kind of sub-graph.

Tiler: Creates grid and jittered grid patterns of a single sub-graph

SoundCache: A buffer containing digital sound. Sound, like images, can be procedural or sampled; combinations or effects can be applied by building up the desired graph. Sound can also be controlled by interactive elements.

### Scripts and Binary Files

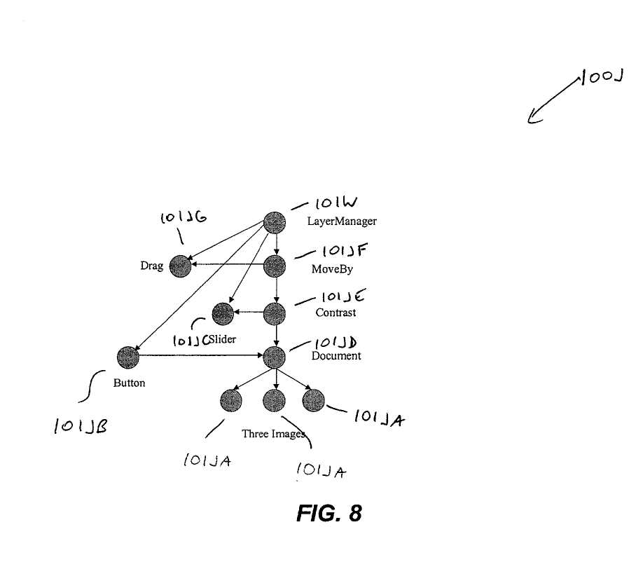

Referring now to FIG. 8, there is shown an example of a data flow graph 100J for moving image elements and changing the characteristics of image elements. Data flow graph 100J includes a set of three image nodes 101JA that can be dragged around like sprites, a button node 100JB to switch the image elements presented in document node 101JD between three alternatives, and a slider 101JC to change the contrast of the image elements. Drag node 101JG allows the user to drag the image on the screen. MoveBy node 101JF controls the movement specified by drag node 101JG.

Graph 100J can be represented by a script such as the following:

<Document

ID = images
Source = image1
Source = image2
Source = image3

/ Document >
<LayerManager

Source = <MoveBy

BeginPoint = <Drag

ID = sprite_position
IdleState = images
OverState = images
SelectState = images

/Drag>
Source = <Contrast

Intensity = <Slider

ID = brightness
IdleState = knob
OverState = knob
SelectState = knob

/Slider>

/Contrast>

/MoveBy>
Source = brightness
Source = sprite_position

/LayerManger>

The script is perfectly isomorphic to the graph, because it simply specifies nodes 101 and connections 102 using exactly the same topology as graph 100J.

In one embodiment, as described in U.S. patent application Ser. No. 09/429,853 for “Online Focused Content Generation, Delivery, and Tracking,” filed Oct. 28, 1999, the disclosure of which is incorporated herein by reference, RMS builds complete authoring tools and publishes the rich media content by stripping out the user interface elements. The user interface elements might be provided as part of an authoring tool, and are then removed so as to fix the characteristics of the authored content for publishing. Published content can then be reduced to a size that is significantly smaller than the original authoring tool. The removal of user interface elements is accomplished by tagging elements to be removed. For example, slider node 101JC is replaced by a constant number node, drag node 101JG is replaced by a constant vector node, document node 101JD is replaced by a node representing its current page, and the like. Alternatively, if the author wishes the final content to be interactive, some or all of the interactive elements may be retained. This concept can be extended to many levels, leading to tools that make tools that make interactive content.

### User Interface Example

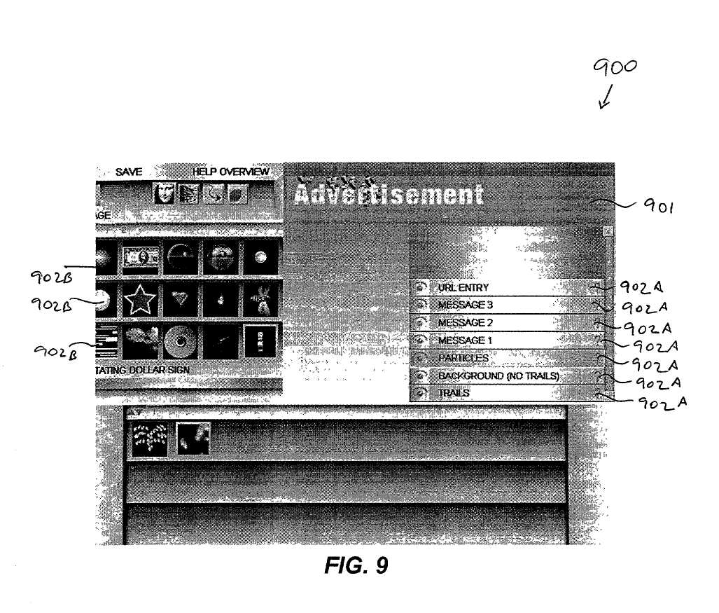

Referring now to FIG. 9, there is shown an example of a user interface 900 for an authoring environment according to the present invention, in any number of user interface nodes 101 control the creation of a banner advertisement 901. Nodes 101 are represented by controls 902A, source images 902B, and the like. The graph implementing user interface 900 contains approximately 150,000 nodes. It has seven layers and allows the authoring of images, particle systems, backgrounds, text and their attributes, such as color, motion, transparency, and the like.

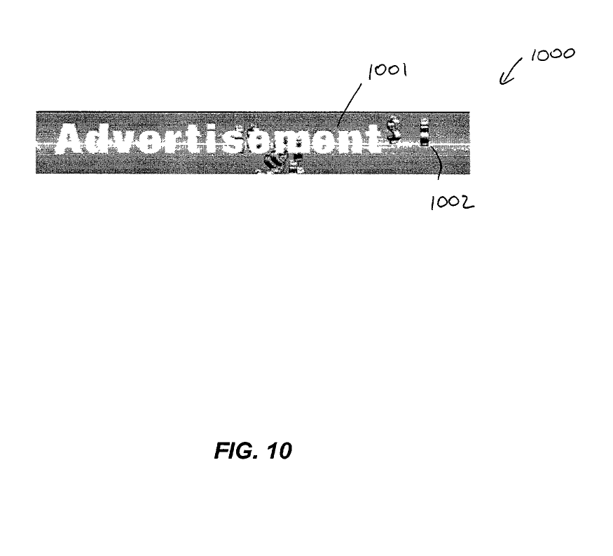

Referring now to FIG. 10, there is shown an animated advertisement 1000 that is published from the above authoring tool. Text 1001 characteristics and particle 1002 characteristics, as well as background colors, size, shape, and the like, are all controlled by nodes 101 that are in turn configurable via user interface 900.

The graph 100 for the published advertisement 1000 is the same graph as was used for authoring the image, but with the user interface nodes 101 removed. Once published, graph 100 now has approximately 1500 nodes 101, in contrast to the 150,000 nodes 101 used for implementing the authoring environment. Publishing thus saves the advertisement according to its appearance in the authoring tool. Stripping away user interface nodes 101 can lead to completely different graphs, depending on the particular values and parameters selected by the author at the time of publishing. Because the final published advertisement utilizes the same graph (without the user interface), the animation, colors and rendered objects are all identical to what the author selected. The invention thus provides a true What-You-See-Is-What-You-Get (WYSWYG) environment.

As can be seen from the above examples, the present invention provides mechanisms and techniques for representing software applications through the use of data flow graphs and for facilitating self-modifying software. The invention is thus able to provide improved flexibility and capability in software implementations, and avoid the limitations of prior art compile-and-run schemes. As will be understood by those familiar with the art, the invention may be embodied in other specific forms without departing from the spirit or essential characteristics thereof. For example, the particular architectures depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, features, attributes, or any other aspect is not mandatory or significant, and the mechanisms that implement the invention or its features may have different names or formats. Accordingly, the disclosure of the present invention is intended to be illustrative, but not limiting, of the scope of the invention, which is set forth in the following claims.

What is claimed is:

1. A system for representing and executing software, comprising:
a representation of a data graph, the data graph comprising:
a plurality of nodes representing mutually polymorphic objects; and
at least one connection, each connection representing data flow between two nodes;
a real-time compiler, coupled to the data graph representation, for compiling the data graph into code; and
an execution module, coupled to the compiler, for executing the compiled code.
